(19) United States
(12) Patent Application Publication
(10) Pub. No.: US 2026/0163133 A1
(43) Pub. Date: Jun. 11, 2026

(54) Prismatic Battery Cell and Method of Making the Same

(71) Applicant: NantG Power, LLC, El Segundo, CA (US)

(72) Inventors: Fabio ALBANO, El Segundo, CA (US); Taylor JURAN, El Segundo, CA (US); Daniel ROBERTSON, El Segundo, CA (US); Chun-Han LAI, El Segundo, CA (US); Eben PROSTAK, El Segundo, CA (US); Derrick DUONG, El Segundo, CA (US); George BAURE, El Segundo, CA (US); Nathan DUNLAP, El Segundo, CA (US); Jagjot GREWAL, El Segundo, CA (US); Sean BARRETT, El Segundo, CA (US); Patrick SOON-SHIONG, El Segundo, CA (US)

(21) Appl. No.: 19/411,048

(22) Filed: Dec. 5, 2025

Related U.S. Application Data
(60) Provisional application No. 63/729,035, filed on Dec. 6, 2024.

(51) Int. Cl. H01M 50/15; H01M 4/58; H01M 4/62; H01M 10/058; H01M 50/103; H01M 50/169; H01M 50/507; H01M 50/522

(52) U.S. Cl. CPC H01M 50/15; H01M 4/5825; H01M 4/625; H01M 10/058; H01M 50/103; H01M 50/169; H01M 50/507; H01M 50/522

(57) ABSTRACT

A prismatic battery cell and method of making the same are disclosed. The prismatic battery cell comprises a container configured to accommodate the prismatic battery cell, including a positive electrode, a negative electrode an ionically conductive separator, and an electrolyte. The positive electrode comprises a lithium manganese iron phosphate active material combined with a conductive carbon additive and a binder. The prismatic battery cell further comprises a lid, a first busbar, a second busbar, a positive electrode terminal attached to the first busbar, and a negative electrode terminal attached to the second busbar.

### CROSS-REFERENCE TO RELATED PATENT APPLICATION

This application claims the benefit of U.S. Provisional Ser. No. 63/729,035, filed Dec. 6, 2024, entitled “Prismatic Battery Cell and Method of Making the Same,” the entirety of which is incorporated by reference herein.

### FIELD

Apparatuses and methods consistent with the present disclosure relate generally to energy storage systems, specifically, prismatic battery cell configurations.

### BACKGROUND

As battery technology develops, battery cells are applied to increasingly more fields and are gradually replacing traditional petrochemical energy sources in the automotive industry. Known battery cells store chemical energy and convert the chemical energy into electrical energy under controlled conditions. In a recyclable battery cell, active material can be re-charged for repeated use.

Lithium iron phosphate (LFP) cathode materials have attracted interest due to their cost-effective manufacturing processes and safety advantages compared to lithium nickel manganese cobalt oxide (“NMC”) cathode materials. LFP cathode active materials are relatively less expensive, and do not rely on rare earth metals or elements such as cobalt, which are relatively scarce in North America. Its robust phosphate polyanion crystal structure offers substantial safety, cycle-and calendar-life advantages over NMC, which is inherently unstable in a charged state. However, LFP's relatively low specific capacity (˜160 mAh/g—LFP vs. ˜190 mAh/g—NMC) and flat, two-phase (Fe²⁺—Fe³⁺) reaction potential (˜3.4 V—LFP vs. ˜3.7 V—NMC), limit achievable energy densities (˜530 Wh/kg—LFP vs. ˜700 Wh/kg—NMC). What is needed is a phosphate-based cathode material providing improved performance over current commercially available LFP materials.

A potential solution is a LiFe₁₋ₓMnₓPO₄ (LMFP) battery. LMFP operates by two distinct redox processes; Fe²⁺—Fe³⁺ at 3.5V and Mn²⁺—Mn³⁺ at 4.1V, bringing its average working potential up to ˜4.0 V vs. Li. With a theoretical specific capacity approximately equal to that of LFP (˜160 mAh/g), this increased operating potential increases LMFP's energy density to over 600 Wh/kg—substantially higher than that of LFP (530 Wh/kg), and almost approaching that of SOA NMC (700 Wh/kg).

Battery cells typically include a container and an electrode assembly disposed within the container. In commercially available battery cells, improving volumetric energy density is difficult because the space inside the container is often limited and achieving higher volumetric energy density typically requires special designs. As such, the space available inside the container makes it difficult to add additional components, restricting the technical development of the battery cell.

The present disclosure describes a prismatic battery cell prototype made with an LMFP cathode. The prototype improves space utilization and current carrying capacity by using busbars to carry and distribute current from the container to the electrodes. The design improves mechanical integrity, electrical power, and safety.

The present disclosure also seeks to improve energy density by employing laser welding techniques to bond the sides and lid of the container to one another. Busbars available in the prior art are typically more expensive and heavier than other current carrying apparatus. However, the present disclosure seeks to take advantage of both the busbars'increased current carrying capacity, spot-welding techniques, and the busbars'unique configuration to improve energy density, battery performance, and cell stackability.

### SUMMARY

Embodiments of the present disclosure include a prismatic battery cell comprising: a container that forms a protective enclosure for and that is configured to accommodate the prismatic battery cell, including: a positive electrode, a negative electrode, an ionically conductive separator, and an electrolyte, wherein the positive electrode comprises a LMFP active material, at least one conductive carbon additive, and at least one binder.

Additional embodiments of the present disclosure include a method for forming a prismatic battery cell, the method comprising: providing a container configured to accommodate the prismatic cell; providing a positive electrode terminal, a negative electrode terminal, an ionically conductive separator, and an electrolyte; providing a first busbar configured to carry electrical current; providing a second busbar configured to carry electrical current; attaching a positive electrode terminal to the first busbar; and attaching a negative electrode terminal to the second busbar.

Additional embodiments of the present disclosure still further include a busbar assembly for a prismatic battery cell comprising: a first busbar configured to carry electrical current, wherein the first busbar is bent to connect to a positive electrode terminal; and a second busbar, wherein the second busbar is bent to connect to a negative electrode terminal.

### BRIEF DESCRIPTION OF FIGURES

FIG. 1 is an isometric view of a prismatic battery cell, consistent with disclosed embodiments.

FIG. 2A is an isometric cutaway view of a prismatic battery cell, consistent with disclosed embodiments.

FIG. 2B is an isometric view of a cover assembly for a prismatic battery cell, consistent with disclosed embodiments.

FIG. 3 is a cross-section view of a prismatic battery cell wherein the first fastener and second fastener are eliminated, consistent with disclosed embodiments.

FIG. 4 is an isometric view of a prismatic battery cell wherein the first fastener and second fastener are eliminated, consistent with disclosed embodiments.

FIG. 5 is an isometric view of an isolator for use in a prismatic battery cell, consistent with disclosed embodiments.

FIG. 6 is a blown-up cross-section view of a prismatic battery cell, consistent with disclosed embodiments.

FIG. 7 is a blown-up cross-section view of a prismatic battery cell, with the fasteners, washers, and isolator hidden, consistent with disclosed embodiments.

FIG. 8A is an exploded view of a cover assembly for a prismatic battery cell, consistent with disclosed embodiments.

FIG. 8B is a cross-section of a cover assembly for a prismatic battery cell, consistent with disclosed embodiments.

FIG. 8C is a top view of a cover assembly for a prismatic battery cell, consistent with disclosed embodiments.

FIG. 9 is a flowchart illustrating a method for forming a prismatic battery cell, consistent with this disclosure.

FIG. 10 is a Ragone plot comparing the current cell design and chemistry to technologies available in the prior art, consistent with disclosed embodiments.

FIG. 11 is a plot illustrating galvanostatic charge and discharge curves for an exemplary LMFP cathode.

FIG. 12 is a plot illustrating capacity retention with respect to cycle number during long term cycling for an exemplary LMFP cathode.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Rather, they are examples of systems, apparatuses, and methods consistent with the present disclosure, as recited in the appended claims.

Embodiments of the present disclosure are expected to reduce the overall cell volume in a prismatic battery cell and are also expected to improve volumetric energy density when combined with other aspects of the current disclosure. To do so, embodiments include a first busbar disposed in a prismatic battery cell, as described elsewhere in this disclosure. In some embodiments, the first busbar is an electrically conductive strip configured to carry and distribute electrical current. Here, the first busbar is configured to accommodate and distribute electrical current generated by electrochemical components housed in a container, as described an exemplified elsewhere in this disclosure. Busbars are typically used in power plants and substations because they provide a low-resistance path for large current; they reduce the risk of overheating or short circuits; and they are more reliable than other means of transporting current available in the prior art.

Embodiments also include a second busbar disposed in the prismatic battery cell. In some embodiments, the second busbar is an electrically conductive strip, similarly configured to carry and distribute electrical current generated by electrochemical components housed in the container.

First and second busbars are configured to connect to a larger number of electrodes relative to prior art configurations. For example, groups of electrodes can be welded in multiple locations to each of the first and second busbars. Each of the first and second busbars are therefore able to carry and distribute more current to the positive electrode terminal and negative electrode terminal respectively than current commercially available prismatic battery cells.

Embodiments comprise a prismatic battery cell. Prismatic battery cells refer to battery cells that are prismatic or rectangular in shape, in contrast to pouch cells, which have a flexible, flat design, or cylindrical cells, which are typically enclosed in a rigid cylinder container. Compared to other battery cell designs, prismatic battery cells provide efficient space utilization and stackability. Prismatic cells are typically used for more energy-intensive applications, such as in electric vehicles, electric trucks, and/or commercial buildings settings. The disclosed prismatic battery cell is expected to have a capacity of up to 320 Ah.

In some embodiments, the prismatic battery cell includes a container. A “container” refers to a protective enclosure, typically including a rigid shell, which is used to accommodate the electrochemical components of the cell, such as least one positive electrode, at least one negative electrode, at least one ionically conductive separator, and an electrolyte. As used herein, “accommodate” refers to being able to fit one or more components. Here, the container is configured to accommodate positive electrode, cathode, conductive separator, and electrolyte. In one embodiment, the container is rectangular in shape but may also be triangular or any other shape designed to facilitate cell stacking or being disposed in available space in the application in which it is deployed.

A positive electrode terminal is the electrode terminal where reduction occurs and electrons are accepted from an external circuit. Positive electrodes (sometimes referred to as cathodes during battery discharge) typically include an active material; oxidizable metal (e.g., lithium); material capable of intercalating the oxidizable metal (e.g., graphite or silicon); electrolyte; a binder (e.g., polyethylene oxide, polyacrylonitrile, polyvinylidene fluoride, or polyvinylidene fluoride-hexafluoropropylene), where the binder or binding material refers to material used to ensure contact between an active material and conductive additives, and anchors those materials to the current collector; and an electronically conductive additive. Active materials in the cathode may include but are not limited to olivine materials (such as LFP or LMFP), layered oxide materials and spinel materials. Conductive carbon material may comprise, for example, carbon nanotubes, carbon nanoparticles, carbon black, carbon fiber, graphite, graphene, and/or combinations thereof. Consistent with disclosed embodiments, the positive electrode may contain, by weight at least 80% active material, between 1% and 10% conductive material, and/or between 1% and 10% binding material. In one example, the positive electrode may contain, by weight, 80%, 85%, 90%, 95%, or 98% active material, and any percentage in between. In another example, the positive electrode may contain, by weight, 1%, 2%, 3%, 4%, 5%, 6%, 7%, 8%, 9%, or 10% conductive material. In yet another example, the positive electrode may contain, by weight, 1%, 2%, 3%, 4%, 5%, 6%, 7%, 8%, 9%, or 10% binder material.

A negative electrode terminal is the electrode terminal where oxidation occurs and electrons are released to an external circuit. A negative electrode (sometimes referred to as the anode) typically includes metal foil as a current collector such as aluminum, titanium, nickel, or nickel foil. The negative electrode may also include conductive carbon such as graphite, graphene, or carbon nanotubes. Consistent with disclosed embodiments, the positive electrode terminal and negative electrode terminal may be circular, rectangular, threaded, L-shaped, flat-tabbed, and/or U-shaped. In another example, the positive electrode terminal and/or the negative electrode may include a flat metallic centerpiece with grooves and a through-hole for laser-welding to the first and second busbar. The shape of the electrode terminal affects battery cell characteristics. For example, a larger contact area reduces resistance. In another example, a ring or stud shape may resist loosening under vibration. In yet another example, flat tabs and L-terminals may streamline battery cell assembly. Each of the positive and negative electrodes may be configured to form an electrical connection with each of the first and second busbars.

A separator refers to material that sits between the positive electrode and the negative electrode and is configured to keep the electrodes separate to prevent short circuits. The separator may be an ionically conductive material, such as porous polymer (e.g., polyolefins), polymer electrolyte (e.g., polystyrene-polyethylene oxide (PS-PEO)), ceramic (e.g., lithium phosphorous oxynitride (LiPON), lithium aluminum titanium phosphate (LATP), or lithium aluminum germanium phosphate (LAGP)), and/or 2-dimensional sheet structures (e.g., graphene, boron nitride, or dichalcogenides).

An electrolyte refers to a substance that permits current to flow between the positive electrode and the negative electrode. The electrolyte may be solid or liquid and may be configured to facilitate the electrochemical reaction in a prismatic battery cell. The electrolyte is necessary for solid to liquid conversion reactions. The weight of the electrolyte may be reduced by reducing cathode porosity. Electrolyte may include at least one of LITFSI, LIBOB, and EC:DMC. Electrolyte may comprise only one of these compounds or may be a mixture of one or more of the compounds.

In some embodiments, the sides of container are welded to one another. The sides of container may be spot-welded or laser welded. Spot welding and/or laser welding improves space utilization because it takes less space and avoids the need for collateral fastening components. Consistent with the disclosed embodiments, the container may be configured accommodate more electrochemical components (i.e., active material), compared to other bonding methods. Laser welding refers to a welding technique used to join pieces of metal or thermoplastics using a laser. The beam provides a concentrated heat source, allowing for narrow, deep welds and high welding rate. In battery cells, laser welding ensures that less material is needed to bond materials together, allowing more electrochemical components to be housed within container. Spot welding refers to a type of electric resistance welding in which contacting metal surface points are joined by the heat obtained from resistance to electric current. In In one embodiment, the sides are laser welded.

In some embodiments, the prismatic battery cell includes a lid. The lid may be machined steel, aluminum, and/or any commercially available steel or aluminum alloy. The lid may be configured to protect the electrochemical components housed in container, and may be configured to attach to the container. For example, the lid may be configured to provide a fluid-tight seal to prevent electrolyte leakage and ingress of air or moisture, thereby ensuring the stability of the electrochemical environment within the prismatic battery cell. In one embodiment, the lid is laser welded to the container, which allows for more electrochemical components to be housed in the container, and therefore improves space utilization and volumetric energy density.

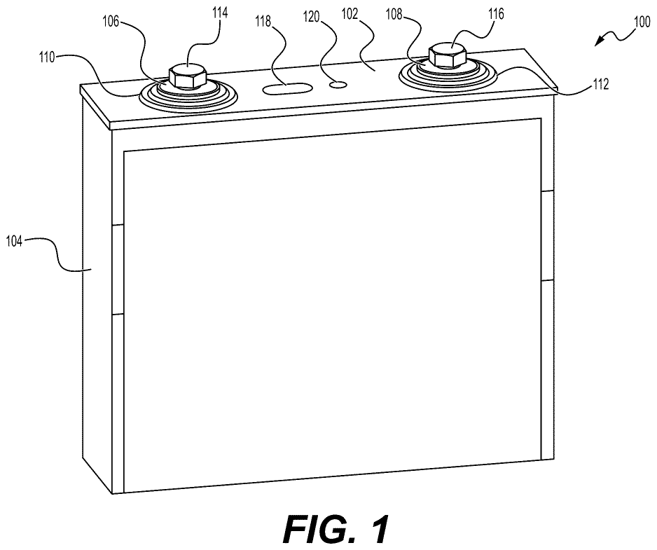

By way of example, FIG. 1 is an isometric view of prismatic battery cell 100, consistent with disclosed embodiments. Prismatic battery cell 100 includes lid 102. In this example, lid 102 is made of metal, comprising machined steel, aluminum, and/or any other metal that protects the internal battery cell components. In an embodiment, lid 102 is laser welded to container 104. In another embodiment, lid 102 is spot welded to container 104. Container 104 may comprise machined steel, aluminum, and/or any other commercially available metal or metal alloy designed to protect the internal battery cell components, i.e., the positive and negative electrodes, the separator, and the electrolyte. In an embodiment, container 104 is generally rectangular in shape.

Referring to FIG. 1, prismatic battery cell 100 includes positive electrode terminal 106 and negative electrode terminal 108. In this embodiment, positive electrode terminal 106 and negative electrode terminal 108 may be coated with nickel-plated steel. Positive electrode terminal 106 may be configured to accommodate first fastener 114, and negative electrode terminal 108 can be configured to accommodate second fastener 116. Each of first and second fasteners 114 and 116 can be configured to fasten lid 102 to container 104.

In some embodiments, ad referring to FIG. 1, prismatic battery cell 100 includes first washer 110. As used herein, first washer 110 refers to a structure configured to electrically isolate the positive electrode terminal from lid 102. In an embodiment, first washer 110 is plastic and can be overmolded onto positive electrode terminal. Potential plastic materials for first washer may include polyester (PET), polypropylene (PP), polytetrafluoroethylene (PTFE), polyvinyl chloride (PVC), polycarbonate (PC), and/or acrylonitrile butadiene styrene (ABS).

Consistent with disclosed embodiments, and referring to FIG. 1, prismatic battery cell 100 includes second washer 112. In this example, second washer 112 is plastic and may be similarly configured to electrically isolate negative electrode terminal 108 from lid 102. Potential plastic materials for second washer 112 may include those described elsewhere in this disclosure. In an embodiment, second washer 112 may similarly be overmolded onto negative electrode terminal 108. Each of first and second washers may inhibit electrical current from being conducted to lid 102. In this example, first washer 110 is configured to electrically isolate positive electrode terminal 106 from lid 102, whereas second washer 112 is configured to electrically isolate negative electrode terminal from lid 102.

As described elsewhere in this disclosure, embodiments include a first busbar, wherein the first busbar is an electrically conductive strip configured to carry and distribute electrical current. Embodiments also include a second busbar, as described and exemplified elsewhere in this disclosure. In some embodiments, the second busbar is an electrically conductive strip, similarly configured to carry and distribute electrical current generated by electrochemical components housed in the container. The first and second busbars are configured to connect to a larger number of electrodes relative to prior art configurations. Groups of electrodes can be welded in multiple locations to each of first and second busbar. Each of the first and second busbars are expected to carry and distribute more current to the positive electrode terminal and negative electrode terminal respectively than current commercially available prismatic battery cells.

Consistent with disclosed embodiments, each of first and second busbar's current carrying ability varies based on the thickness of the busbar. Thicker or wider busbars may carry and distribute more current, whereas thinner or narrower busbars may carry and distribute less current. The thickness of the busbar may be adjusted based on the end user's needs and charge/discharge requirements. In some embodiments, including energy-intensive applications, such as in electric vehicles, electric trucks, and/or commercial buildings settings, the thickness of the busbar may be between 0.1 mm and 2 mm. Each busbar may be between 0.1 mm and 5 mm thick. In this example, the width of the busbar is between 10 mm and 115 mm. Generally, each busbar is preferably between 10 mm and 200 mm wide.

Consistent with disclosed embodiments, the first busbar is bent to connect to positive electrode terminal. The first busbar may be bent 30, 45, 60, or 90 degrees, or any angle between 0 and 90 degrees. In an embodiment, the first busbar is bent 90 degrees. Bending the first busbar reduces transferring unwanted vibrations from the electrochemical components to the positive electrode terminal, which improves mechanical stability of the prismatic battery cell. The transfer of such vibration is proportional to the cosine of the bend angle. For a busbar bent 90 degrees, the cosine of the bend angle is zero, thus, energy transfer is minimized. Consistent with disclosed embodiments, the second busbar is similarly bent to connect to negative electrode terminal to similarly prevent unwanted vibrations. The second busbar may similarly be bent 30, 45, 60, or 90 degrees, or any angle between 0 and 90 degrees. In an embodiment, the second busbar is bent 90 degrees. Each of the first busbar and the second busbar may be bent using equipment such as a hydraulic busbar bending machine.

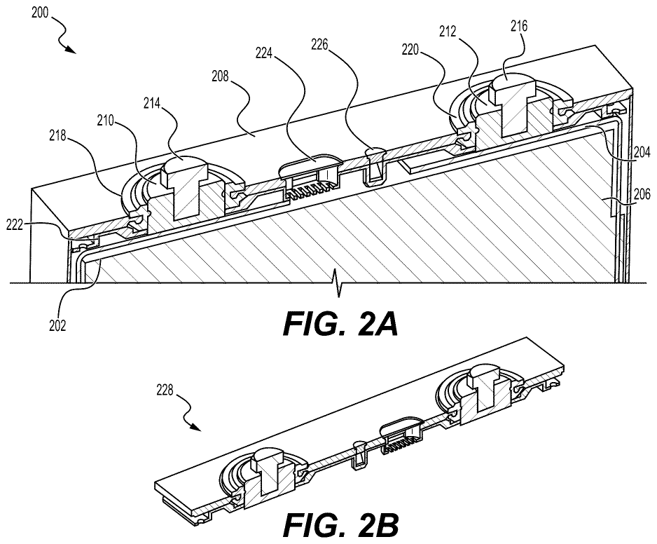

FIG. 2A is an isometric cutaway view of prismatic battery cell 200, which is similar to prismatic battery cell 100 described in relation to FIG. 1. FIG. 2A illustrates first busbar 202 and second busbar 204, each configured to accommodate electrical current generated by electrochemical components housed in container 206. First busbar 202 may comprise copper, brass, nickel-plated steel, aluminum, aluminum-cladded copper, and/or nickel-cladded copper. In an embodiment, the first busbar 202 is copper. In an embodiment, the second busbar 204 includes brass, nickel-plated steel, aluminum, aluminum-cladded copper, and/or nickel-cladded copper. In one embodiment, the second busbar 204 is aluminum. Each different material possesses different current-carrying properties and other characteristics. For example, while copper is the most conductive material, it is not as mechanically strong or corrosion resistant as some other materials, such as nickel-plated steel. Accordingly, busbar 202 may be constructed of a material that is appropriate for the prismatic battery cell's practical application.

In some embodiments, prismatic battery cell 200 includes a positive electrode terminal (such as, for example, positive electrode terminal 210) attached to the first busbar 202. In some embodiments, the positive electrode terminal 210 may include a first groove and first aperture formed therein, the first aperture being configured to accommodate a first fastener, as described and exemplified elsewhere in this disclosure. In a non-limiting example, the positive electrode terminal 210 includes nickel-plated steel and may also include copper, brass, tin-plated copper, and/or aluminum. In an embodiment, the positive electrode terminal 210 may be laser welded to first busbar 202. Positive electrode terminal 210 may also be spot welded to first busbar 202. In an embodiment, the positive electrode terminal may be laser welded to the first busbar 202. In a similar fashion, the positive electrode terminal 210 may be spot welded to the first busbar 202. First and second apertures formed in positive electrode terminal and negative electrode terminal may be threaded, smooth, or any desired texture.

In some embodiments, prismatic battery cell 200 includes a negative electrode terminal (such as, for example, positive electrode terminal 212) attached to the second busbar 204. In some embodiments, the positive electrode terminal 212 may include a second groove and second aperture formed therein, the second aperture being configured to accommodate a second fastener, as described and exemplified elsewhere in this disclosure. In a non-limiting example, the positive electrode terminal 210 includes nickel-plated steel and may also include copper, brass, tin-plated copper, and/or aluminum. In an embodiment, the negative electrode terminal 212 may be laser welded to second busbar 204. Negative electrode terminal 212 may also be spot welded to second busbar 204. In an embodiment, the negative electrode terminal may be laser welded to the second busbar 204. In a similar fashion, the negative electrode terminal 212 may be spot welded to the second busbar 204. First and second apertures formed in positive electrode terminal and negative electrode terminal may be threaded, smooth, or any desired texture.

In some embodiments, the positive electrode terminal (such as, for example, positive electrode terminal 210) includes a first groove and the negative electrode terminal (such as, for example, negative electrode terminal 212) includes a second groove, wherein each of the first and second grooves are configured to accommodate overmolding as described and exemplified elsewhere in this disclosure. As described herein, overmolding may include plastic and may separate the positive electrode terminal from the lid. In some embodiments, the positive electrode terminal may be configured to accommodate a first fastener. The fastener may be a hex bolt, polymer screw, and/or a hex nut. Fasteners are typically used in battery cells to secure battery terminal connections, as described and exemplified elsewhere in this disclosure.

Referring to FIG. 2A, prismatic battery cell 200 includes lid 208. As discussed herein, lid 208 may comprise machined steel or aluminum. Prismatic battery cell 200 also includes positive electrode terminal 210 and negative electrode terminal 212. Positive electrode terminal 210 is configured to accommodate first fastener 214, and negative electrode terminal 212 is configured to accommodate second fastener 216.

Referring to FIG. 2A, prismatic battery cell 200 includes first washer 218, where first washer 218 is configured to electrically isolate positive electrode terminal 210 from lid 208. Prismatic battery cell 200 includes second washer 220, where second washer 220 is similarly configured to electrically isolate negative electrode terminal 212 from lid 208.

In some embodiments, prismatic battery cell 200 includes isolator 222 configured to isolate lid from first busbar 202 and second busbar 204. Isolator 222 may be formed via injection molding. Isolator may comprise electrically insulating materials such as polypropylene, polycarbonate, acrylonitrile butadiene styrene (ABS), and/or LDPE. Referring to FIG. 2A, isolator 222 is disposed adjacent to first busbar 202 and second busbar 204, and between lid 208 and container 206.

Consistent with disclosed embodiments, isolator 222 includes a first annular portion configured to accommodate positive electrode terminal 210, as described and exemplified elsewhere in this disclosure. First annular portion may be stamped, pressed, drilled, or formed in any suitable method to accommodate positive electrode terminal. In some embodiments, isolator 222 includes a second annular portion. The second annular portion may be configured to accommodate the negative electrode terminal, such as, for example, negative electrode terminal 212. Similar to the first annular portion, second annular portion may be formed by stamping, pressing, or drilling.

In some embodiments, isolator 222 includes vent 224. In a non-limiting example, vent 224 is configured to relieve built-up internal pressure that may accumulate as a result of a faulty charger, external or internal cell shorting, and/or exposure to excessive heat (e.g., fire), etc. Vent 224 may be created via injection molding, or may be drilled, stamped, or pressed.

Isolator 222 may also contain electrolyte fill port 226. Electrolyte fill port 226 may be formed by injection molding, drilling, stamping, or pressing. Electrolyte fill port 226 may be configured to accommodate liquid electrolyte, which is used to sustain the ongoing chemical reaction within prismatic battery cell 100. Referring to FIG. 2A, isolator 222 includes vent 224 and electrolyte fill port 226.

FIG. 2B is an isometric view of a cover assembly for a prismatic battery cell, consistent with disclosed embodiments. In some embodiments, prismatic battery cell 200 include cover assembly 228. Consistent with disclosed embodiments, cover assembly 228 includes lid 208, positive electrode terminal 210, negative electrode terminal 212, first fastener 214, second fastener 216, first washer 218, second washer 220, and isolator 222. Isolator 222 includes vent 224 and electrolyte fill port 226.

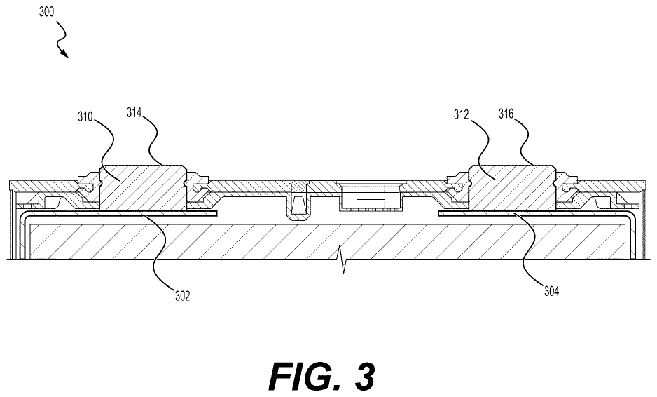

FIG. 3 is cross-section view of prismatic battery cell 300 (which is similar to, for example, prismatic battery cell 100 described in relation to FIG. 1) wherein the first fastener and second fastener (such as, for example, first fastener 214 and second fastener 216, described in reference to FIG. 2A) are eliminated, consistent with disclosed embodiments. In this example, busbars 302 and 304 may be laser welded to positive electrode terminal 310 and negative electrode terminal 312. In lieu of the first fastener and the second fastener, positive electrode terminal 310 contains first welding surface 314 and negative electrode terminal 312 contain second welding surface 316. Including first and second welding surfaces 314 and/or 316 on positive electrode terminal 310 and/or negative electrode terminal 312, respectively, may enable prismatic battery cell 300 to be more easily integrated into larger battery packs and/or energy storage systems. While mechanical fasteners, such as first fastener 214 or second fastener 216 (as described in reference to FIG. 2A), may provide faster battery cell assembly, they are not desirable for high throughput production because fewer cells may be stacked, welded, or otherwise incorporated into a larger battery pack or energy storage system. Additionally, including a welding surface on positive electrode terminal 310 and/or negative electrode 312 may enable prismatic battery cell 300 to better withstand mechanical vibration in transportation, use, and/or heavy machinery applications.

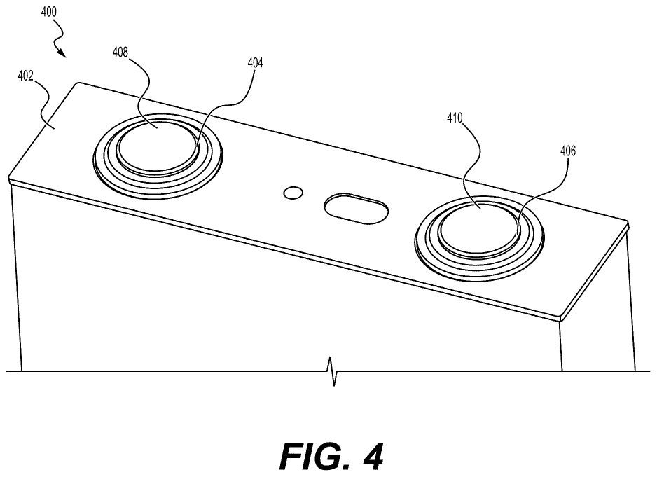

FIG. 4 is an isometric view of prismatic battery cell 400 wherein the first fastener and second fastener (such as, for example, first fastener 214 and second fastener 216, as described in reference to FIG. 2A) are eliminated (as described in reference to FIG. 3), consistent with disclosed embodiments. As discussed herein, prismatic battery cell 400 includes lid 402. In lieu of first fastener 214 and second fastener 216, as described in reference to FIG. 2A, FIG. 4 illustrates positive electrode terminal 404 and negative electrode terminal 406 with first welding surface 408 and second welding surface 410, respectively.

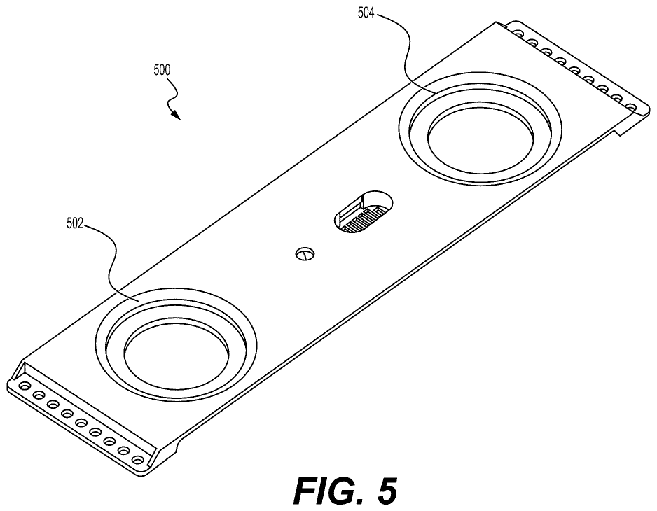

FIG. 5 is an isometric view of isolator 500, consistent with disclosed embodiments. Isolator 500 includes annular portions 502, 504, configured to accommodate positive and negative electrode terminals 210, 212.

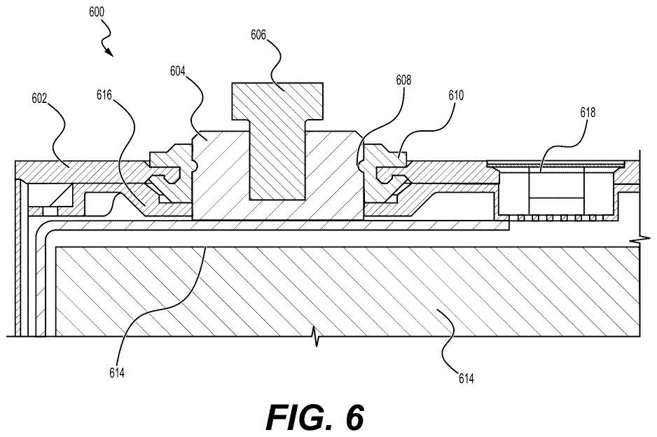

By way of example, FIG. 6 is a blown-up cross-section view of prismatic battery cell 600 (similar to prismatic battery cell 100, as described in reference to FIG. 1), consistent with disclosed embodiments. The components described with respect to FIG. 6 are similar to the components described elsewhere throughout this disclosure. In this non-limiting example, prismatic battery cell 600 includes lid 602. Prismatic battery cell 600 further includes positive electrode terminal 604 configured to accommodate a first fastener 606. Positive electrode terminal 604 includes groove 608. Groove 608 is configured to accommodate first washer 610. In this example, first washer 610 may be overmolded onto first electrode terminal 604. First washer 610 is configured to electrically isolate positive electrode terminal 604 from lid 602.

Prismatic battery cell 600 also includes first busbar 612. Positive electrode terminal 604 may be spot-welded or laser-welded to first busbar 612. In one embodiment, first busbar 612 is made of copper. In another example, first busbar 612 is made of nickel-plated steel, or any other material or alloy as described and exemplified in this disclosure. First busbar 612 may be configured to carry and distribute current from electrochemical components 614 to positive electrode terminal 604. Prismatic battery cell 600 also includes isolator 616, which includes vent 618.

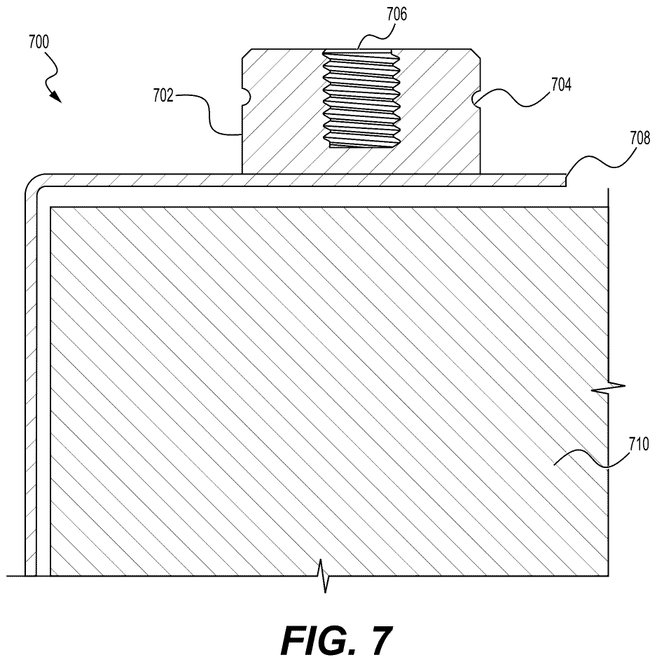

FIG. 7 is a blown-up cross-section view, consistent with disclosed embodiments, of prismatic battery cell 700, with each fastener (such as, for example, first fastener 214 and second fastener 216), washer (such as, for example, first washer 218 and second washer 220), and isolator (such as, for example, isolator 222) hidden. The components of prismatic battery cell 700 are similar to those components described and exemplified elsewhere in this disclosure. Positive electrode terminal 702 contains an aperture 706 formed therein, configured to accommodate a fastener (such as, for example, first fastener 214). In one embodiment, aperture 706 may be threaded to accommodate such a fastener. In another example, aperture 706 may be eliminated and replaced with a welding surface (such as, for example, welding surface 314).

In this example, positive electrode terminal 702 is connected to first busbar 708. Positive electrode terminal 702 may be spot-welded or laser-welded to first busbar 708. In an embodiment, the positive electrode terminal (such as, for example, positive electrode terminal 502) is laser welded to first busbar 708 via one or more edges of aperture 706. In some embodiments, first busbar 708 includes copper. FIG. 5 also illustrates electrochemical components housed in container 710. Current travels from electrochemical components in container 710 through first busbar 708 to positive electrode terminal 702.

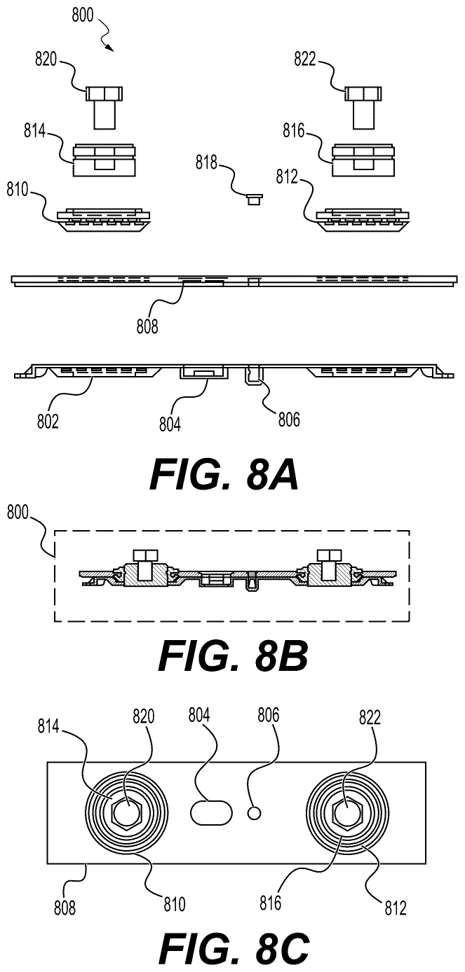

FIG. 8A is an exploded view of cover assembly 800 for, for example, prismatic battery cell 100, consistent with disclosed embodiments. The components described with respect to FIGS. 8A-8C are similar to those components described and exemplified elsewhere in this disclosure. Turning to FIG. 8A, cover assembly 800 includes isolator 802, vent 804, and electrolyte fill port 806.

Cover assembly 800 further includes lid 808. As disclosed herein, lid 808 may be configured to protect exemplary prismatic battery cell 100 from damage and environmental conditions, such as excess heat. Cover assembly further 800 includes first washer 810 and second washer 812. First washer 810 is configured to electrically isolate positive electrode terminal 814, and second washer 812 is configured to electrically isolate negative electrode terminal 816. In an embodiment, positive electrode terminal 814 and negative electrode terminal 816 comprise nickel-plated steel.

Cover assembly 800 further includes electrolyte fill port cap 818, which is configured to prevent contaminants from intruding into exemplary prismatic battery cell 100. Positive electrode terminal 814 is configured to accommodate first fastener 820, and negative electrode terminal 816 is configured to accommodate second fastener 822. FIG. 8B is cross-section of cover assembly 800, consistent with disclosed embodiments.

FIG. 8C is a top view of cover assembly 800, consistent with disclosed embodiments. As discussed elsewhere in this disclosure, cover assembly 800 includes lid 808. Lid 808 is rectangular in shape. Cover assembly 800, specifically isolator 802, also includes vent 804, electrolyte fill port 806, first and second fasteners 820, 822 and first and second washers 810, 812.

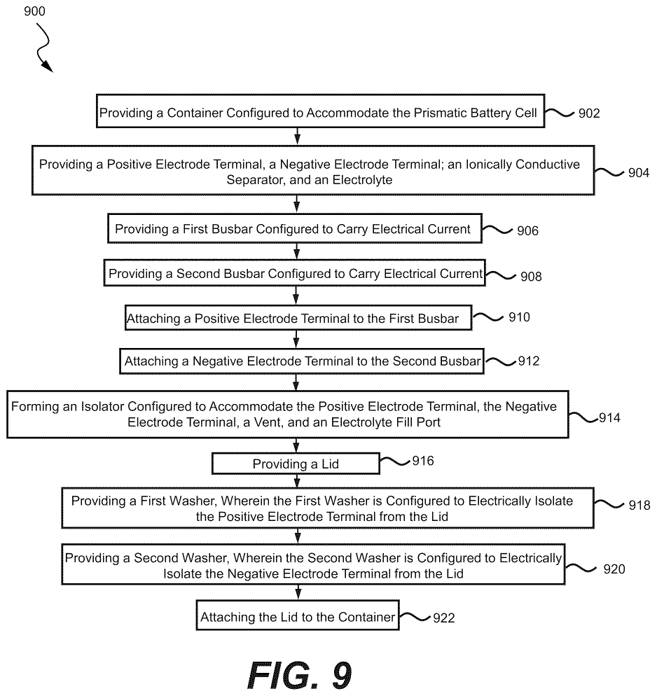

By way of example, FIG. 9 is a flowchart illustrating a method 900 for forming a prismatic battery cell, consistent with this disclosure. Some steps must be performed in order, and other steps are not required to be performed in order. Method 900 includes step 902 of providing a container (such as, for example, container 104) configured to accommodate the prismatic battery cell. Method 900 further includes providing a positive electrode terminal, a negative electrode terminal, an ionically conductive separator, and an electrolyte at step 904. Method 900 further includes step 906 of providing a first busbar (such as, for example, first busbar 202) configured to conduct electric current. Method 900 further includes step 908 of providing a second busbar (such as, for example, second busbar 204) configured to conduct electric current. Steps 902 through 908 may be performed in order.

At step 910, method 900 includes attaching a positive electrode terminal (such as, for example, positive electrode terminal 106) to the first busbar (such as, for example, first busbar 202). Step 910 may be performed after steps 902 through 908. At step 912, method 900 includes attaching a negative electrode terminal (such as, for example, negative electrode terminal 108) to the second busbar (such as, for example, second busbar 204). Step 912 may be performed after steps 902 through 908.

At step 914, method 900 includes forming an isolator (such as, for example, isolator 222) configured to accommodate the positive electrode terminal, the negative electrode terminal, a vent (such as, for example, vent 118), and an electrolyte fill port (such as, for example, electrolyte fill port 120). Step 914 may be performed after step 912, but is not required to be performed after step 912.

At step 916, method 900 includes providing a lid (such as, for example, lid 102). In some embodiments, step 916 is required to be performed after step 914, to ensure that the lid is isolated from the first and second busbars. At step 918, method 900 includes providing a first washer (such as, for example, first washer 110), wherein the first washer is configured to electrically isolate positive electrode terminal from the lid. At step 920, method 900 includes providing a second washer (such as, for example, second washer 112), wherein the second washer is configured to electrically isolate the negative electrode terminal from the lid. Consistent with disclosed embodiments, the first washer and the second washer may be overmolded, formed via injection molding, and/or formed via additive manufacturing. Steps 918 and 920 may be performed after step 916, but steps 918 and 920 may be performed in any order. At step 922, method 900 includes attaching the lid to the container.

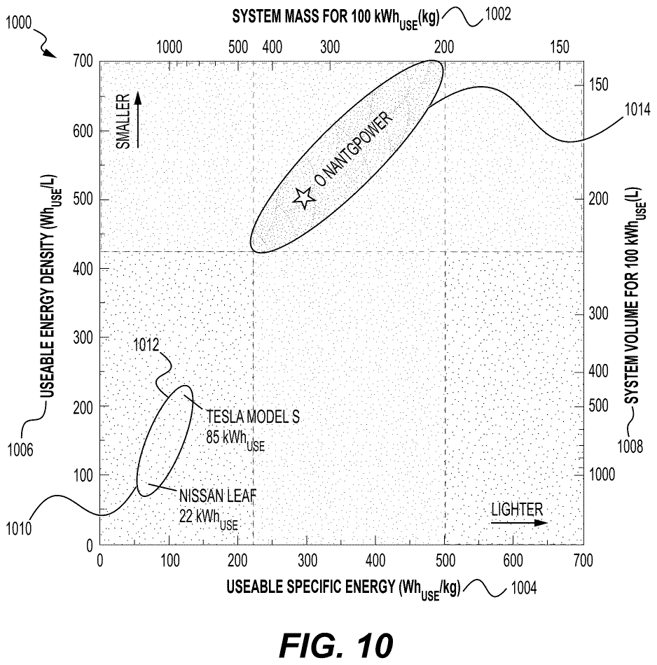

FIG. 10 is a Ragone plot 1000 comparing the current cell design and chemistry consistent with disclosed embodiments to technologies known in the prior art. Ragone plots are generally used to compare energy density between multiple energy storage devices. Ragone plot 1000 shows the system mass 1002 for 100 kwH output, measured in kilograms (kg), compared to the useable specific energy 1004, measured in watt-hours per kilogram. Ragone plot 1000 also shows useable energy density 1006, measured in watt-hours per liter, and system volume 1008 for a 100 kwH output, measured in liters.

Ragone plot 1000 illustrates the energy storage capacity of a NISSAN LEAF 1010 and a TESLA MODEL S 1012. In this example, Ragone plot 1000 shows that a 22 kWh battery pack for NISSAN LEAF 1010 has usable specific energy of approximately 75 Wh/kg and a usable specific energy density of approximately 90 Wh/L. In another example, Ragone plot 1000 shows that a 85 kWh battery pack associated with TESLA MODEL S 1012 has a usable specific energy of approximately 125 Wh/kg and 225 Wh/L.

By comparison, and illustrated by energy storage results 1014, some embodiments a usable specific energy, including the end points, is expected to range between 200 Wh/kg and 500 Wh/kg, such as between 200 Wh/kg and 450 Wh/kg, between 200 Wh/kg and 400 Wh/kg, between 200 Wh/kg and 350 Wh/kg, between 200 Wh/kg and 300 Wh/kg, between 200 Wh/kg and 250 Wh/kg, between 250 Wh/kg and 300 Wh/kg, between 250 Wh/kg and 350 Wh/kg, between 250 Wh/kg and 400 Wh/kg, between 250 Wh/kg and 450 Wh/kg, between 250 Wh/kg and 500 Wh/kg, between 300 Wh/kg and 350 Wh/kg, between 350 Wh/kg and 400 Wh/kg, between 350 Wh/kg and 450 Wh/kg, between 350 Wh/kg and 500 Wh/kg, between 400 Wh/kg and 450 Wh/kg, between 400 Wh/kg and 500 Wh/kg, or between 450 Wh/kg and 500 Wh/kg.

In some embodiments, a cell energy density, including the end points, is expected to range between 400 Wh/L and 700 Wh/L, such as between 400 Wh/L and 650 Wh/L, between 400 Wh/L and 600 Wh/L, between 400 Wh/L and 550 Wh/L, between 400 Wh/L and 500 Wh/L, between 400 Wh/L and 450 Wh/L, between 450 Wh/L and 700 Wh/L, between 450 Wh/L and 650 Wh/L, between 450 Wh/L and 600 Wh/L, between 450 Wh/L and 550 Wh/L, between 450 Wh/L and 500 Wh/L, between 500 Wh/L and 700 Wh/L, between 500 Wh/L and 650 Wh/L, between 500 Wh/L and 600 Wh/L, between 500 Wh/L and 550 Wh/L, between 550 Wh/L and 700 Wh/L, between 550 Wh/L and 650 Wh/L, between 550 Wh/L and 600 Wh/L, between 600 Wh/L and 700 Wh/L, or between 600 Wh/L and 650 Wh/L.

In some embodiments, a power density, including the end points, is expected to range between 1,000 W/L and 8,500 W/L, between 1,000 W/L and 7,500 W/L, between 1,000 W/L and 6,500 W/L, between 1,000 W/L and 5,500 W/L, between 1,000 W/L and 4,500 W/L, between 1,000 W/L and 3,500 W/L, between 1,000 W/L and 2,500 W/L, between 1,000 W/L and 1,500 W/L, between 1,500 W/L and 8,500 W/L, between 1,500 W/L and 7,500 W/L, between 1,500 W/L and 6,500 W/L, between 1,500 W/L and 5,500 W/L, between 1,500 W/L and 4,500 W/L, between 1,500 W/L and 3,500 W/L, between 1,500 W/L and 2,500 W/L, between 2,000 W/L and 7,500 W/L, between 2,000 W/L and 6,500 W/L, between 2,000 W/L and 5,500 W/L, between 2,000 W/L and 4,500 W/L, between 2,000 W/L and 3,500 W/L, between 2,000 W/L and 2,500 W/L, between 2,500 W/L and 7,500 W/L, between 2,500 W/L and 6,500 W/L, between 2,500 W/L and 5,500 W/L, between 2,500 W/L and 4,500 W/L, between 2,500 W/L and 3,500 W/L, between 3,000 W/L and 7,500 W/L, between 3,000 W/L and 6,500 W/L, between 3,000 W/L and 5,500 W/L, between 3,000 W/L and 4,500 W/L, between 3,000 W/L and 3,500 W/L, between 3,500 W/L and 7,500 W/L, between 3,500 W/L and 6,500 W/L, between 3,500 W/L and 5,500 W/L, between 3,500 W/L and 4,500 W/L, between 4,000 W/L and 7,500 W/L, between 4,000 W/L and 6,500 W/L, between 4,000 W/L and 5,500 W/L, or between 4,000 W/L and 4,500 W/L.

In some embodiments, a specific power density, including the end points, is expected to range between 600 W/kg and 6,000 W/kg, between 1,000 W/kg and 6,000 W/kg, between 1,000 W/kg and 5,000 W/kg, between 1,000 W/kg and 4,000 W/kg, between 1,000 W/kg and 3,000 W/kg, between 1,000 W/kg and 2,000 W/kg, between 2,000 W/kg and 6,000 W/kg, between 2,000 W/kg and 5,000 W/kg, between 2,000 W/kg and 4,000 W/kg, between 2,000 W/kg and 3,000 W/kg, between 3,000 W/kg and 6,000 W/kg, between 3,000 W/kg and 5,000 W/kg, between 3,000 W/kg and 4,000 W/kg, between 4,000 W/kg and 6,000 W/kg, or between 4,000 W/kg and 5,000 W/kg.

In some embodiments, the compact and efficient electrode arrangement and the enhanced packing density within the cell will enable superior energy density and specific energy compared to commercially available alternatives in the prior art. Additionally, the cell design of the present disclosure provides for lower temperature development during charge and discharge and for enhanced power capabilities.

Embodiments of the present disclosure include a prismatic battery cell with a positive electrode made with LMFP cathode active material. With an appropriate cell design, olivine cathode materials can exhibit long cycle life due to their stability upon removal and insertion of lithium ions.

Consistent with disclosed embodiments, the LMFP active material may contain a ratio of manganese to iron between 1.2:1 and 9:1, and the conductive carbon additive may be carbon particles, graphene, or combinations thereof. As described and exemplified elsewhere in this disclosure, the conductive carbon material may be monolayered, multilayered, or comprise a carbon network. In another embodiment, the conductive carbon material may be another carbon allotrope. A carbon allotrope refers to a different form in which a chemical element can exist in the same physical state, arising from different arrangement or bonding of its atoms. Examples of carbon allotropes may be graphite, graphene, or carbon nanotubes. A higher ratio of manganese in a LMFP generally leads to higher capacity retention at high charge and discharge rates, which means that a higher ratio of manganese in the disclosed prismatic battery cell is able to charge faster and deliver more power than commercially available embodiments in the prior art. A higher concentration of manganese also helps the battery cell maintain conductivity and voltage stability under low-temperature conditions. Finally, manganese is more abundant in North America and is cheaper than nickel or cobalt, which reduces reliance on such materials. The disclosed high-Mn formulations may eliminate cobalt entirely, make the disclosed prismatic cell more sustainable.

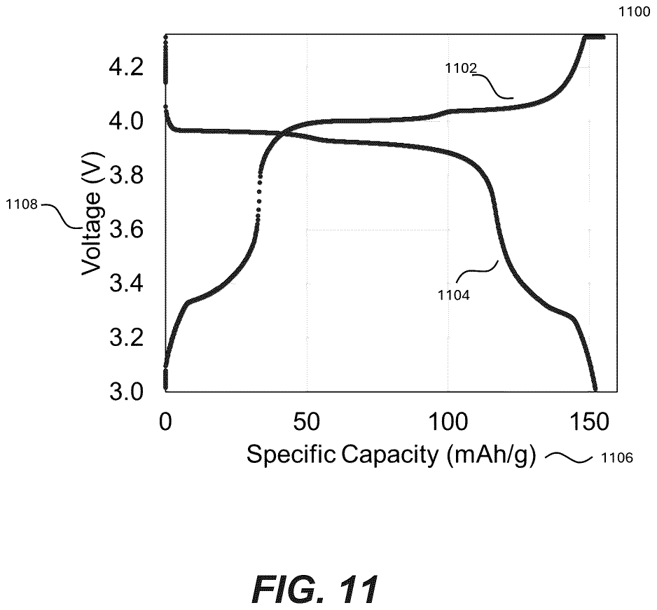

By way of example FIG. 11 is a plot 1100 illustrating a galvanostatic charge curve 1102 and discharge curve 1104 for an exemplary LMFP cathode. In this example, x-axis 1106 illustrates the LMFP battery's specific capacity in milliampere-hours per gram (mAh/g), ranging from 0 to approximately 150 mAh/g, and y-axis 1108 illustrates the measured voltage in volts (V), using a voltage window of between 0 and approximately 4.2V. Voltage may also be measured in millivolts.

The results illustrated in FIG. 11 were achieved using a LMFP cathode, cycled at constant charge and discharge rate. Charge curve 1102 illustrates that a voltage of approximately 4.2V was measured after LMFP cathode was fully charged, and discharge curve 1104 illustrates that a voltage of approximately 3V was measured after LMFP cathode was fully discharged.

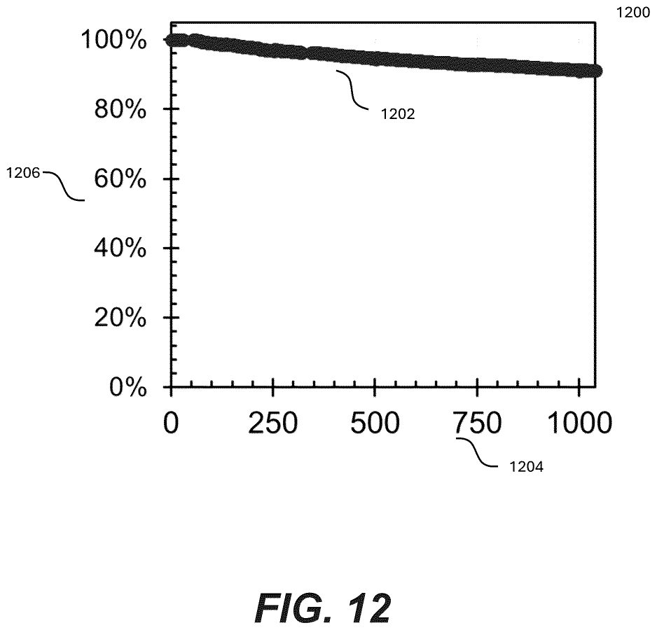

By way of example, FIG. 12 is a plot 1200 illustrating capacity retention with respect to cycle number during long term cycling for an exemplary LMFP cathode. The x-axis 1204 in corresponds to the number of cycles, i.e., where the LMFP cell is fully charged and fully discharged. The y-axis 1206 corresponds to the LMFP cell's percentage of storage capacity. In this example, the LMFP cell maintained nearly 90% capacity over 1,000 cycles.

The present disclosure, in connection with the accompanying drawings, describes sample configurations that are not exhaustive or representative of all the examples that may be implemented or all configurations that are within the scope of the present disclosure. The term “exemplary” should not be construed as “preferred” or “more advantageous relative to other examples” but rather “an illustration, an instance, or an example.”

By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Examples of inventive concepts are contained in the following clauses which are an integral part of this disclosure.
Clause 1: A prismatic battery cell, comprising:
   a container that forms a protective enclosure for and that is configured to accommodate the prismatic battery cell, including:
   a positive electrode, a negative electrode, an ionically conductive separator, and an electrolyte;
   wherein the positive electrode comprises a lithium manganese iron phosphate (LMFP) active material, at least one conductive carbon additive, and at least one binder.
Clause 2: The prismatic battery cell of clause 1, where the LMFP active material contains a ratio of manganese to iron between 1.2:1 and 9:1.
Clause 3: The prismatic battery cell of clause 1 or 2, wherein the positive electrode comprises, by weight:
   at least 80% active material;
   between 1% and 10% conductive material; and
   between 1% and 10% binding material.
Clause 4: The prismatic battery cell of any one of clauses 1 to 3, wherein the at least one conductive carbon material comprises carbon particles, graphene, or a combination of carbon and graphene.
Clause 5: The prismatic battery cell of any one of clauses 1 to 4, wherein the conductive carbon material is monolayered, multilayered, or comprises a network of carbon allotropes selected from the group comprising carbon nanotubes, graphite, and graphene.
Clause 6: The prismatic battery cell of any one of clauses 1 to 5, wherein the container includes:
   a first busbar configured to carry electrical current;
   a second busbar configured to carry electrical current;
   a positive electrode terminal forming an electrical connection with the first busbar; and
   a negative electrode terminal forming an electrical connection with the second busbar.
Clause 7: The prismatic battery cell of any one of clauses 1 to 6, wherein the lid is laser welded to the container.
Clause 8: The prismatic battery cell of any one of clauses 1 to 7, wherein the lid is rectangular.
Clause 9: The prismatic battery cell of any one of clauses 1 to 8, wherein at least one of the positive electrode terminal or the negative electrode terminal is circular.
Clause 10: The prismatic battery cell of any one of clauses 1 to 9, wherein at least one of the positive electrode terminal or the negative electrode terminal comprises nickel-plated steel.
Clause 11: The prismatic battery cell of any one of clauses 1 to 10, wherein the first busbar comprises copper.
Clause 12: The prismatic battery cell of any one of clauses 1 to 11, wherein the positive electrode terminal is laser welded to the first busbar.
Clause 13: The prismatic battery cell of any one of clauses 1 to 12, wherein the second busbar comprises aluminum.
Clause 14: The prismatic battery cell of any one of clauses 1 to 13, wherein the negative electrode terminal is laser welded to the second busbar.
Clause 15: The prismatic battery cell of any one of clauses 1 to 14 wherein each of the positive electrode terminal and the negative electrode terminal further comprises a welding surface.
Clause 16: The prismatic battery cell of any one of clauses 1 to 15, wherein each of the first busbar and second busbar is between 0.1 mm and 2 mm in thickness.
Clause 17: The prismatic battery cell of any one of clauses 1 to 16, having a cell energy density between 400 Wh/L and 700 Wh/L.
Clause 18: The prismatic battery cell of any one of clauses 1 to 17, having a specific energy between 200 Wh/kg and 500 Wh/kg.
Clause 19: The prismatic battery cell of any one of clauses 1 to 18, having a power density between 1,200 W/L and 8,400 W/L.
Clause 20: The prismatic battery cell of any one of clauses 1 to 19, having a specific power between 600 W/kg and 6,000 W/kg.
Clause 21: A method for forming a prismatic battery cell, the method comprising:
   providing a container configured to accommodate the prismatic battery cell;
   providing a positive electrode terminal, a negative electrode terminal, an ionically conductive separator, and an electrolyte;
   providing a first busbar configured to carry electrical current;
   providing a second busbar configured to carry electrical current;
   attaching a positive electrode terminal to the first busbar;
   attaching a negative electrode terminal to the second busbar;
Clause 22: The method of clause 21, further comprising
   attaching the positive electrode terminal to the first busbar using laser welding;
   attaching the negative electrode terminal to the second busbar using laser welding; and
   attaching the lid to the container using laser welding.
Clause 23: A busbar assembly for a prismatic battery cell comprising:
   a first busbar configured to carry electrical current, wherein the first busbar is bent to connect to a positive electrode terminal; and
   a second busbar configured to carry electrical current, wherein the second busbar is bent to connect to a negative electrode terminal.
Clause 24: The busbar assembly of clause 23, wherein the first busbar comprises copper.
Clause 25: The busbar assembly of clause 23 or 24, wherein the second busbar comprises aluminum.

Disclosed embodiments may include any one of the following bullet-pointed features alone or in combination with one or more other bullet-pointed features, whether implemented as a device, system, apparatus, and/or method.
a prismatic battery cell
a container that forms a protective enclosure for and that is configured to accommodate the prismatic battery cell.
a positive electrode, a negative electrode, an ionically conductive separator, and an electrolyte.
a positive electrode comprises a lithium manganese iron phosphate (LMFP) active material, at least one conductive carbon additive, and at least one binder.
LMFP active material contains a ratio of manganese to iron between 1.2:1 and 9:1.
A positive electrode comprises, by weight: at least 80% active material; between 1% and 10% conductive material; and between 1% and 10% binding material.
at least one conductive carbon material comprises carbon particles, graphene, or a combination of carbon and graphene.
a conductive carbon material is monolayered, multilayered, or comprises a network of carbon allotropes selected from the group comprising carbon nanotubes, graphite, and graphene.
a container that includes: a first busbar configured to carry electrical current; a
second busbar configured to carry electrical current; a positive electrode terminal forming an electrical connection with the first busbar; and a negative electrode terminal forming an electrical connection with the second busbar.
a lid is laser welded to the container.
a lid that is rectangular.
at least one of the positive electrode terminal or the negative electrode terminal is circular.
at least one of the positive electrode terminal or the negative electrode terminal comprises nickel-plated steel.
a first busbar that comprises copper.
a positive electrode terminal that is laser welded to the first busbar.
a second busbar comprising aluminum.
a negative electrode terminal is laser welded to the second busbar.
a positive electrode terminal and the negative electrode terminal that further comprises a welding surface.
each of the first busbar and second busbar is between 0.1 mm and 2 mm in thickness.
a cell energy density between 400 Wh/L and 700 Wh/L.
a prismatic cell having specific energy between 200 Wh/kg and 500 Wh/kg.
a prismatic cell having a power density between 1,200 W/L and 8,400 W/L.
a prismatic cell having a specific power between 600 W/kg and 6,000 W/kg.
a method for forming a prismatic battery cell.
a method comprising: providing a container configured to accommodate the
prismatic battery cell; providing a positive electrode terminal, a negative electrode terminal, an ionically conductive separator, and an electrolyte; providing a first busbar configured to carry electrical current; providing a second busbar configured to carry electrical current; attaching a positive electrode terminal to the first busbar; attaching a negative electrode terminal to the second busbar.
method further comprising attaching the positive electrode terminal to the first busbar using laser welding; attaching the negative electrode terminal to the second busbar using laser welding; and attaching the lid to the container using laser welding.
a busbar assembly for a prismatic battery cell.
a busbar assembly for a prismatic battery cell comprising a first busbar configured to carry electrical current, wherein the first busbar is bent to connect to a positive electrode terminal; and a second busbar configured to carry electrical current, wherein the second busbar is bent to connect to a negative electrode terminal.
a busbar assembly wherein the first busbar comprises copper.
a busbar assembly wherein the second busbar comprises aluminum.

What is claimed is:

1. A prismatic battery cell, comprising:
a container that forms a protective enclosure for and that is configured to accommodate the prismatic battery cell, including:
a positive electrode, a negative electrode, an ionically conductive separator, and an electrolyte;
a lithium manganese iron phosphate (LMFP) active material, at least one conductive carbon additive, and at least one binder.

2. The prismatic battery cell of claim 1, where the LMFP active material contains a ratio of manganese to iron between 1.2:1 and 9:1.

3. The prismatic battery cell of claim 1, wherein the positive electrode comprises, by weight:
at least 80% active material;
between 1% and 10% conductive material; and
between 1% and 10% binding material.

4. The prismatic battery cell of claim 1, wherein the at least one conductive carbon material comprises carbon particles, graphene, or a combination of carbon and graphene.

5. The prismatic battery cell of claim 1, wherein the conductive carbon material is monolayered, multilayered, or comprises a network of carbon allotropes selected from the group comprising carbon nanotubes, graphite, and graphene.

6. The prismatic battery cell of claim 1, wherein the container includes:
a first busbar configured to carry electrical current;
a second busbar configured to carry electrical current;
a positive electrode terminal forming an electrical connection with the first busbar; and
a negative electrode terminal forming an electrical connection with the second busbar.

7. The prismatic battery cell of claim 1, wherein the lid is laser welded to the container.

8. The prismatic battery cell of claim 1, wherein the lid is rectangular.

9. The prismatic battery cell of claim 1, wherein at least one of the positive electrode terminal or the negative electrode terminal is circular.

10. The prismatic battery cell of claim 1, wherein at least one of the positive electrode terminal or the negative electrode terminal comprises nickel-plated steel.

11. The prismatic battery cell of claim 6, wherein the first busbar comprises copper.

12. The prismatic battery cell of claim 11, wherein the positive electrode terminal is laser welded to the first busbar.

13. The prismatic battery cell of claim 6, wherein the second busbar comprises aluminum.

14. The prismatic battery cell of claim 13, wherein the negative electrode terminal is laser welded to the second busbar.

15. The prismatic battery cell of claim 6, wherein each of the positive electrode terminal and the negative electrode terminal further comprises a welding surface.

16. The prismatic battery cell of claim 6, wherein each of the first busbar and second busbar is between 0.1 mm and 2 mm in thickness.

17. The prismatic battery cell of claim 1, having a cell energy density between 400 Wh/L and 700 Wh/L.

18. The prismatic battery cell of claim 1, having a specific energy between 200 Wh/kg and 500 Wh/kg.

19. The prismatic battery cell of claim 1, having a power density between 1,200 W/L and 8,400 W/L.

20. The prismatic battery cell of claim 1, having a specific power between 600 W/kg and 6,000 W/kg.

21. A method for forming a prismatic battery cell, the method comprising:
providing a container configured to accommodate the prismatic battery cell;
providing a positive electrode terminal, a negative electrode terminal, an ionically conductive separator, and an electrolyte;
providing a first busbar configured to carry electrical current;
providing a second busbar configured to carry electrical current;
attaching a positive electrode terminal to the first busbar;
attaching a negative electrode terminal to the second busbar;

22. The method of claim 21, further comprising:
attaching the positive electrode terminal to the first busbar using laser welding;
attaching the negative electrode terminal to the second busbar using laser welding; and
attaching the lid to the container using laser welding.

23. A busbar assembly for a prismatic battery cell comprising:
a first busbar configured to carry electrical current, wherein the first busbar is bent to connect to a positive electrode terminal; and
a second busbar configured to carry electrical current, wherein the second busbar is bent to connect to a negative electrode terminal.

24. The busbar assembly of claim 23, wherein the first busbar comprises copper.

25. The busbar assembly of claim 23, wherein the second busbar comprises aluminum.
